(19) United States
(12) Patent Application Publication
(10) Pub. No.: US 2024/0270996 A1
(43) Pub. Date: Aug. 15, 2024

(54) Screen-Printing Ink, Method of Manufacturing Same, Method of Producing Screen-Printed Electrode and Screen-Printed Electrode

(71) Applicant: Agency for Science, Technology and Research, Singapore (SG)

(72) Inventors: Wei Peng GOH, Singapore (SG); Changyun JIANG, Singapore (SG); Yong YU, Singapore (SG); Xinting ZHENG, Singapore (SG); Yuxin LIU, Singapore (SG); Le YANG, Singapore (SG)

(73) Assignee: Agency for Science, Technology and Research, Singapore (SG)

(21) Appl. No.: 18/568,072

(22) PCT Filed: Jun. 14, 2022
(86) PCT No.: PCT/SG2022/050407

§ 371 Date: Dec. 7, 2023

(30) Foreign Application Priority Data
Jul. 21, 2021 (SG) 10202107931X

(51) Int. Cl. C09D 11/52; C09D 7/80; C09D 11/037; C09D 11/102; G01N 27/30; H01B 1/24; H01B 5/14

(52) U.S. Cl. CPC C09D 11/52; C09D 7/80; C09D 11/037; C09D 11/102; G01N 27/308; H01B 1/24; H01B 5/14

(57) ABSTRACT

A screen-printing ink, a method (10) of manufacturing the screen-printing ink, a 5 method (50) of producing a screen-printed electrode, and a screen-printed electrode are provided. The screen-printing ink includes graphite, an electrically conductive binder to bind the graphite, a cross-linking agent to cross-link the binder, and at least one of a conductivity modifier and a hydrophobicity modifier.

### FIELD OF THE INVENTION

The present invention relates in general to electrochemical sensors and more particularly to a screen-printing ink, a method of manufacturing the same, a method of producing a screen-printed electrode and a screen-printed electrode.

### BACKGROUND OF THE INVENTION

Wearable sensors for health monitoring are gradually gaining traction in targeting specific physiological biomarkers. For example, useful information can be gleaned by monitoring sweat metabolites such as creatinine, lactate and uric acid in athletes or people engaging in any form of vigorous exercise. Monitoring of sweat metabolites can easily be achieved using epidermal electrochemical sensors.

Electrochemical sensors may be gold-based, silver/silver chloride (Ag/AgCl)-based or carbon-based. Carbon is attractive due to its efficient faradaic properties, low cost, nontoxicity and biocompatibility. It is also simple and inexpensive to process using environmentally-friendly means. However, it suffers from relatively poor conductivity and is hydrophobic.

Carbon electrodes for electrochemical (EC) sensors are widely available in the market. They are typically screen-printed or thermally evaporated on ceramic substrates or sometimes on flexible substrates. The appropriate functionalisation is performed on the electrodes before they can be used as EC sensors. In most cases, the hydrophobic nature of carbon makes it particularly challenging for the electrodes to be functionalised. This may result in sensors not functioning effectively as an electrochemical sensor.

Commercial carbon paste/ink contains mainly organic solvents with some insulating surfactants and binders. The residue of the organic compounds is toxic and leads to incompatibility for on-skin healthcare applications and also results in low electrochemical activity with the inert binder or surfactants on the carbon particle surface. The use of hydrophobic binders in commercial paste/ink results in limited electrochemical surface area.

Due to relative poor conductivity of printed carbon electrodes, a polymer binder is usually needed to form a dense packing of carbon particles in the printed electrodes. Most polymer binders are poor in electrical conductivity and electrochemical activity, which further decreases the electrochemical performance of the printed carbon electrodes.

In view of the foregoing, it would be desirable to provide a screen-printing ink, a method of manufacturing the same, a method of producing a screen-printed electrode and a screen-printed electrode that addresses one or more of the above issues.

### SUMMARY OF THE INVENTION

Accordingly, in a first aspect, the present invention provides a screen-printing ink including graphite, an electrically conductive binder to bind the graphite, a cross-linking agent to cross-link the binder, and at least one of a conductivity modifier and a hydrophobicity modifier.

In a second aspect, the present invention provides a method of manufacturing a screen-printing ink. The method includes: mixing graphite in an electrically conductive binder modified with a cross-linking agent and at least one of a conductivity modifier and a hydrophobicity modifier to form a mixture; and centrifuging the mixture to produce the screen-printing ink.

In a third aspect, the present invention provides a method of producing a screen-printed electrode. The method includes: providing a substrate; screen printing a layer of electrically conductive ink onto the substrate to form an electrically conductive layer; screen printing a layer of the screen-printing ink in accordance with the first aspect onto the electrically conductive layer; and annealing the printed screen-printing ink to form the screen-printed electrode.

In a fourth aspect, the present invention provides a screen-printed electrode including a substrate, an electrically conductive layer formed on the substrate, and the screen-printing ink in accordance with the first aspect screen-printed onto the electrically conductive layer.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic flow diagram illustrating a method of manufacturing a screen-printing ink in accordance with an embodiment of the present invention;

FIG. 2 is a schematic flow diagram illustrating a method of producing a screen-printed electrode in accordance with another embodiment of the present invention;

FIG. 3A is a scanning electron microscope (SEM) image of a screen-printed electrode in accordance with an embodiment of the present invention;

FIG. 3B is an SEM image of a commercially available carbon-based electrode;

FIG. 4A is an enlarged cross-sectional image showing a contact angle of a drop of water on a screen-printed electrode in accordance with an embodiment of the present invention;

FIG. 4B is an enlarged cross-sectional image showing a contact angle of a drop of water on a commercially available carbon-based electrode;

FIG. 5 is a series of cyclic voltammograms of a screen-printed electrode in accordance with an embodiment of the present invention, various electrodes printed in-house with commercially available ink and various commercially available carbon-based electrodes;

FIG. 6A is a graph comparing electrochemical impedance of a screen-printed electrode in accordance with an embodiment of the present invention against that of commercially available carbon electrodes;

FIG. 6B is a graph comparing area normalized impedance of a screen-printed electrode in accordance with an embodiment of the present invention against that of commercially available carbon electrodes; and

FIG. 7 are graphs demonstrating use of screen-printed electrodes in accordance with embodiments of the present invention as a glucose sensor, a pH sensor and a uric acid.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “electrically conductive” as used herein refers to being capable of allowing the flow of electrical charges in one or more directions and the term “binder” as used herein refers to a substance that helps to hold or bind together one or more substances. Examples of electrically conductive binders include, but are not limited to, poly(3,4-ethylenedioxythiophene) polystyrene sulfonate (PEDOT:PSS), polyacetylene, polyaniline, polypyrrole, polythiophene, poly(para-phenylene), poly(phenylenevinylene) and polyfuran.

The term “cross-linking agent” as used herein refers to a substance that forms a bond or a short sequence of bonds that links one polymer chain to another. Examples of cross-linking agents include, but are not limited to, (3-glycidoxypropyl)trimethoxysilane (GPTMS), 3-chloropropyltrimethoxysilane, 3-methacryloxypropyltrimethoxysilane, 3-methacryloxypropyltrimethoxysilane and divinylsulfone.

The term “conductivity modifier” as used herein refers to a compound capable of improving electrical conductivity of a polymer by modifying its structural order and/or composition. Examples of conductivity modifiers include, but are not limited to, dimethyl sulfoxide (DMSO), ethylene glycol, sorbitol, glycerol, zonyl, phosphoric acid, sulfuric acid and sulfonic acid.

The term “hydrophobicity modifier” as used herein refers to a compound capable of rendering a material surface hydrophobic. Examples of hydrophobicity modifiers include, but are not limited to, Nafion, polyurethane, polymethyl methacrylate and polytetrafluoroethylene.

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

The term “methoxysilane compound” as used herein refers to a silane having a methoxy group. Examples of methoxysilane compounds include, but are not limited to, (3-glycidoxypropyl)trimethoxysilane (GPTMS), 3-chloropropyltrimethoxysilane, 3-methacryloxypropyltrimethoxysilane and 3-methacryloxypropyltrimethoxysilane.

The term “polyanion” as used herein refers to a molecule or chemical complex having negative charges at several sites. Examples of polyanions include, but are not limited to, Nafion, poly(acrylic acid sodium salt) and poly(ethylene oxide)-block-poly(sodium 4-vinylbenzenesulfonate).

The term “fluoropolymer-copolymer” as used herein refers to fluorinated compounds coupled with a polymeric functional group. Examples of fluoropolymer-copolymers include, but are not limited to, Nafion, Aquivion, Flemion and Aciplex.

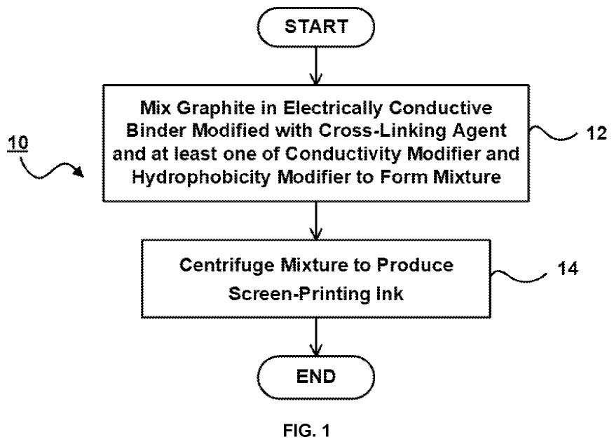

Referring now to FIG. 1, a method 10 of manufacturing a screen-printing ink is shown. The method 10 begins at step 12 by mixing graphite in an electrically conductive binder modified with a cross-linking agent and at least one of a conductivity modifier and a hydrophobicity modifier to form a mixture.

Advantageously, the conducting binder helps to improve electron transfer kinetics. The electrically conductive binder may, for example, be poly(3,4-ethylenedioxythiophene) polystyrene sulfonate (PEDOT:PSS), polyacetylene, polyaniline, polypyrrole, polythiophene, poly(para-phenylene), poly(phenylenevinylene) or polyfuran.

The cross-linking agent may, for example, be a methoxysilane compound such as, for example, (3-glycidoxypropyl)trimethoxysilane (GPTMS), 3-chloropropyltrimethoxysilane, 3-methacryloxypropyltrimethoxysilane or 3-methacryloxypropyltrimethoxysilane, or divinylsulfone.

The conductivity modifier may, for example, be dimethyl sulfoxide (DMSO), ethylene glycol, sorbitol, glycerol, zonyl, phosphoric acid, sulfuric acid or sulfonic acid.

The hydrophobicity modifier may, for example, be a polyanion, polyurethane, polymethyl methacrylate or polytetrafluoroethylene. The polyanion may, for example, be a fluoropolymer-copolymer such as, for example, a sulfonated tetrafluoroethylene based fluoropolymer-copolymer, poly(acrylic acid sodium salt) or poly(ethylene oxide)-block-poly(sodium 4-vinylbenzenesulfonate).

At step 14, the mixture is centrifuged to produce the screen-printing ink. The screen-printing ink includes graphite, an electrically conductive binder to bind the graphite, a cross-linking agent to cross-link the binder, and at least one of a conductivity modifier and a hydrophobicity modifier. Advantageously, the graphite-based paste/ink formulation for screen-printing produced in accordance with method 10 is highly conducting and hydrophilic.

Graphite, an allotrope of carbon, promotes faradaic current and provides a base nanostructure in subsequently formed electrodes for electrochemical sensors. In one or more embodiments, the screen-printing ink may include between about 5 percentage by mass (wt %) and about 50 wt % of the graphite, more preferably, between about 10 wt % and about 50 wt % of the graphite.

The conducting binder provides hydrophilic pathways for aqueous electrolytes and further boosts the faradaic current. In one or more embodiments, the screen-printing ink may include between about 50 wt % and about 90 wt % of the electrically conductive binder. Accordingly, the graphite may be dispersed in the electrically conductive binder. The electrically conductive binder may, for example, be poly(3,4-ethylenedioxythiophene) polystyrene sulfonate (PEDOT:PSS), polyacetylene, polyaniline, polypyrrole, polythiophene, poly(para-phenylene), poly(phenylenevinylene) or polyfuran.

The cross-linker is used to cross-link the electrically conductive binder to promote mechanical robustness and water stability. In one or more embodiments, the screen-printing ink may include between about 1 wt % and about 20 wt % of the cross-linking agent, more preferably, between about 2 wt % and about 20 wt % of the cross-linking agent. The cross-linking agent may, for example, be a methoxysilane compound, such as, for example, (3-glycidoxypropyl)trimethoxysilane (GPTMS), 3-chloropropyltrimethoxysilane, 3-methacryloxypropyltrimethoxysilane or 3-methacryloxypropyltrimethoxysilane, or divinylsulfone.

The conductivity modifier reorganizes the nanostructure of the electrically conductive binder in order to increase conductivity. In one or more embodiments, the screen-printing ink may include between about 0 wt % and about 10 wt % of the conductivity modifier, more preferably, between about 1 wt % and about 10 wt % of the conductivity modifier. The conductivity modifier may, for example, be dimethyl sulfoxide (DMSO), ethylene glycol, sorbitol, glycerol, zonyl, phosphoric acid, sulfuric acid or sulfonic acid.

The hydrophobicity or ionic modifier is used to improve ionic conductivity and to adjust hydrophobicity. In one or more embodiments, the screen-printing ink may include between about 0 wt % and about 50 wt % of the hydrophobicity modifier, more preferably, between about 1 wt % and about 50 wt % of the hydrophobicity modifier.

The hydrophobicity modifier may, for example, be a polyanion, polyurethane, polymethyl methacrylate or polytetrafluoroethylene. The polyanion may, for example, be a fluoropolymer-copolymer such as, for example, a sulfonated tetrafluoroethylene based fluoropolymer-copolymer, poly(acrylic acid sodium salt) or poly(ethylene oxide)-block-poly(sodium 4-vinylbenzenesulfonate). In one or more embodiments, the hydrophobicity modifier may be Nafion 1, Aquivion, Flemion or Aciplex.

In one or more embodiments, the ink/paste formulation may include graphite mixed in a conducting binder of poly(3,4-ethylenedioxythiophene) polystyrene sulfonate (PEDOT:PSS) and modified with (3-Glycidoxypropyl)trimethoxysilane (GPTMS), dimethyl sulfoxide (DMSO) and a fluoropolymer-copolymer (Nafion).

The screen-printable paste formulation may be used to fabricate flexible carbon electrode patterns tailored for multiplexed electrochemical detections in physiological solutions.

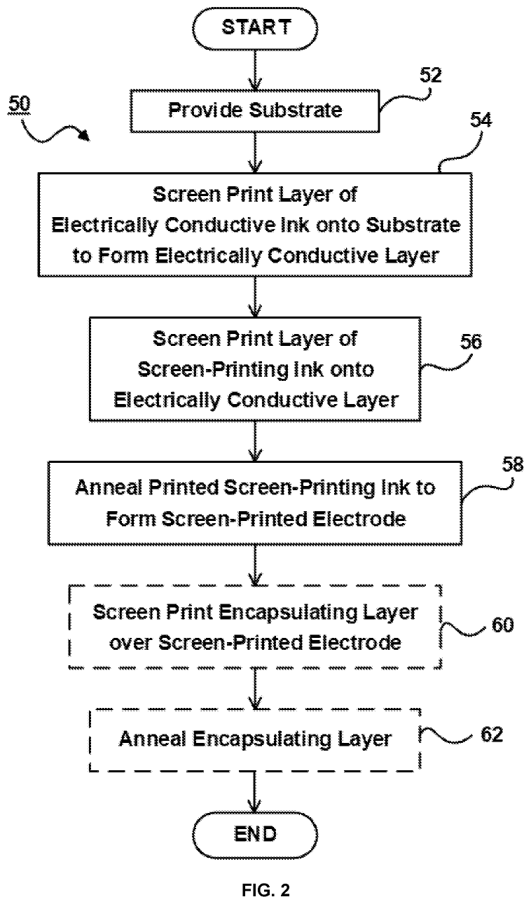

Referring now to FIG. 2, a method 50 of producing a screen-printed electrode is shown. The method 50 begins at step 52 by providing a substrate.

At step 54, a layer of electrically conductive ink is screen printed onto the substrate to form an electrically conductive layer.

At step 56, a layer of the screen-printing ink in accordance with an embodiment of the present invention is screen printed onto the electrically conductive layer.

At step 58, the printed screen-printing ink is annealed to form the screen-printed electrode. The screen-printed electrode includes a substrate, an electrically conductive layer formed on the substrate, and the screen-printing ink in accordance with an embodiment of the present invention screen-printed onto the electrically conductive layer.

An encapsulating layer may be screen printed over the screen-printed electrode at step 60 and the encapsulating layer may be annealed at step 62. The encapsulating layer may include barium titanate.

### Experimental Results

To develop a paste or ink for screen-printing, 1 gram (g) of graphite (Timcal Timrex KS6) was mixed in 3 millilitres (ml) of a conducting binder, poly(3,4-ethylenedioxythiophene) polystyrene sulfonate (PEDOT:PSS) (Heraeus Clevios PH1000), modified with 0.3 ml of (3-Glycidoxypropyl)trimethoxysilane (GPTMS), 0.15 ml of dimethyl sulfoxide (DMSO) and 0.3 ml of a fluoropolymer-copolymer (Nafion). The mixture was asymmetrically centrifuged at 2000 revolutions per minute (rpm) for 5 minutes (min) to produce the graphite-based paste or ink.

Graphite-based electrodes were screen printed using a DEK 265 screen printer. Firstly, polyimide substrates were treated under UV-ozone conditions for 10 min at a temperature of 100 degree Celsius (° C.). Next, silver (Dycotec SIP-3061S) was screen-printed and annealed at 150° C. for 10 min. The printed substrate was UV-ozone treated for 3 min at room temperature to render the surface hydrophilic before screen printing a layer of the graphite-based paste/ink. The printed graphite was annealed at 130° C. for 10 min. Finally, an encapsulating layer of barium titanate (Applied Ink Solutions BT-101) was screen printed before it was annealed at 130° C. for 10 min.

The screen-printed graphite-based paste/ink that was developed is referenced as IMRE screen-printed electrode (SPE) in the subsequent description and corresponding figures.

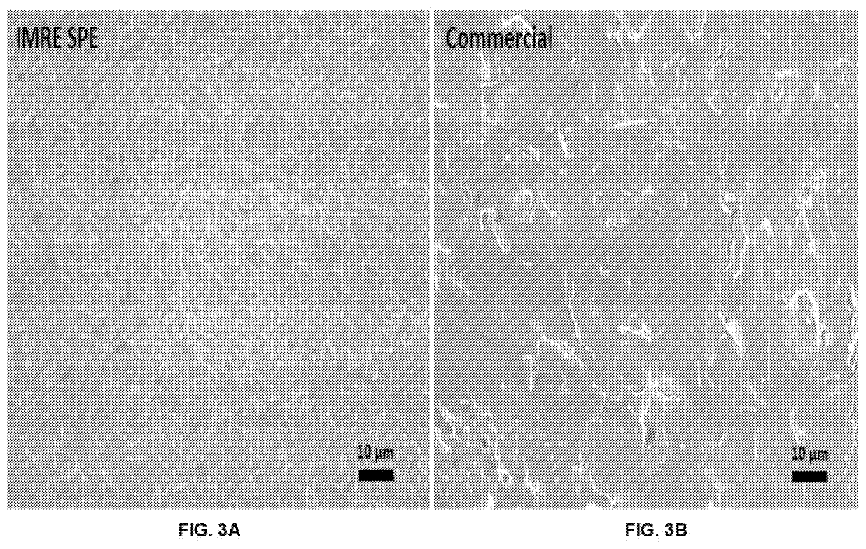

Referring now to FIG. 3A, a scanning electron microscope (SEM) image of the IMRE SPE is shown. Each graphite flake is about 3-5 microns (μm) in diameter. The arrangement of the graphite matrix appears to suggest good percolation with the porosity providing a high active surface area.

Referring now to FIG. 3B, a scanning electron microscope (SEM) image of a typical commercially-available carbon-based electrode (product catalogue number: DropSens C110) is shown for comparison. The typical surface of the commercial counterpart shows a tightly packed surface punctuated with sparse porosity.

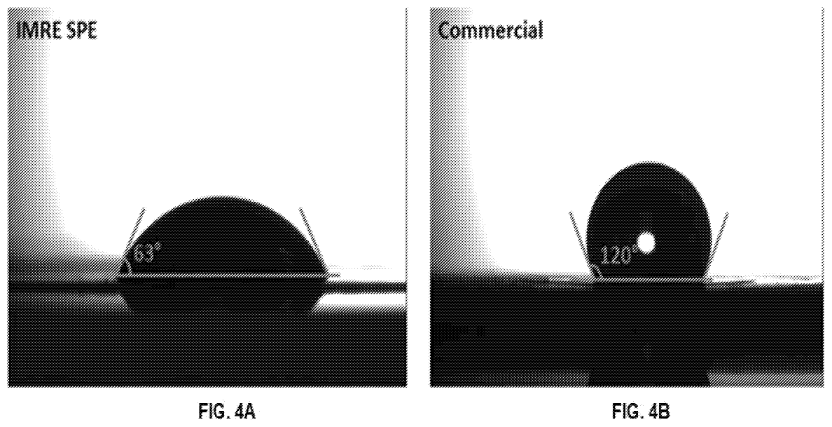

Referring now to FIGS. 4A and 4B, hydrophilicity of the IMRE SPE was tested using a contact angle goniometer. Comparing the contact angle of the screen-printed graphite-based paste/ink shown in FIG. 4A with that of a typical commercially-available carbon electrode (product catalogue number: DropSens C110) shown in FIG. 4B, it can be seen that a more hydrophilic surface is produced using the newly-developed paste/ink formulation.

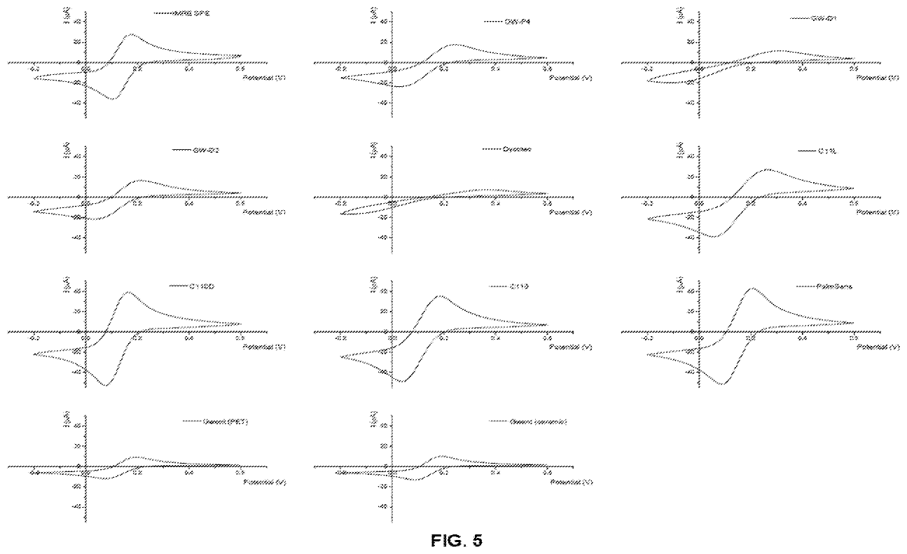

Referring now to FIG. 5, in order to benchmark the performance of the paste/ink in accordance with an embodiment of the present invention against those available in the market, a series of measurements was performed to compare critical parameters such as conductivity/resistance, peak current and active surface area. A number of electrodes, which can be divided into two main categories, i.e., commercial paste/ink purchased from leading companies and printed in-house, and off-the-shelf ready-to-use carbon electrodes from leading suppliers, were subjected to the same test and used as references. Electrode performance was evaluated by a cyclic voltammetry (CV) study using a model redox indicator ferricyanide. Typical cyclic voltammograms of IMRE SPEs recorded in 5 mM potassium ferricyanide/1 M KCl as compared with various types of carbon paste/ink (printed in-house) and commercial electrodes (used directly) are shown in FIG. 5. All scans were recorded at 20 mVs⁻¹.

Based on the CV curves measured, peak-to-peak separation (ΔEp), peak current ratio (ipA/ipC) and (percentage of actual geometric surface area) were calculated. The CV curves of active surface area all the electrodes are shown in FIG. 5 and the calculated peak separation (ΔEp), peak current ratio (ipA/ipC) and active surface area value are summarised in Table 1 below.

TABLE 1

| | | Sheet | | | Active |
|---|---|---|---|---|---|
| | | Resistance | | | Surface |
| No. | Formula | (Ω/□) | ΔEp (mV) | ipA/ipC | Area (%) |
| 1 | IMRE | 14@35 μm | 73 ± 2 | 0.91 ± 0.02 | 99.1 ± 1.0 |
| | SPE | | (CV = 2.9%) | (CV = 2.0%) | (CV = 1.0%) |
| 2 | ^{a}Gwent | <75@25 μm | 269 ± 33 | 0.65 ± 0.11 | 61.2 ± 4.5 |
| | Type 1 | | (CV = 12.4%) | (CV = 16.3%) | (CV = 7.4%) |
| 3 | ^{b}Gwent | <7.5@25 μm | — | — | — |
| | Type 2 | | | | |
| 4 | ^{c}Gwent | <10@25 μm | 216 ± 26 | 0.84 ± 0.16 | 51.3 ± 10.3 |
| | Type 3 | | (CV = 12.1%) | (CV = 18.6%) | (CV = 20%) |
| 5 | ^{d}Gwent | — | 120 ± 2 | 0.98 ± 0.03 | 83.7 ± 0.01 |
| | Type 4 | | (CV = 1.7%) | (CV = 2.8%) | (CV = 0.7%) |
| 6 | ^{e}Gwent | — | 109 ± 10 | 1.00 ± 0.00 | 75.8 ± 0.02 |
| | Type 5 | | (CV = 9.2%) | (CV = 0.5%) | (CV = 2.0%) |
| 7 | ^{f}Gwent | — | 102 | 0.98 | 81.7 |
| | Type 6 | | | | |
| 8 | ^{g}Dycotec | 15 < 75@25 μm | — | — | — |
| | Type 1 | | | | |
| 9 | ^{h}DropSens | — | 210 | 0.81 | 63.1 |
| | Type 1 | | | | |
| 10 | ⁱDropSens | — | 87 ± 1 | 0.95 ± 0.01 | 82.8 ± 1.0 |
| | Type 2 | | (CV = 1.3%) | (CV = 1.4%) | (CV = 1.2%) |
| 11 | ^{j}DropSens | — | 144 | 0.85 | 77.9 |
| | Type 3 | | | | |

^{a}Gwent Type 1: GWP4 (Gwent-C2030519P4, in-house printed)
^{b}Gwent Type 2: GWD1 (Gwent-C2171023D1, in-house printed)
^{c}Gwent Type 3: GWD2 (Gwent-C2130814D2, in-house printed)
^{d}Gwent Type 4: Gwent-C2030519P4 (PalmSens, PET)
^{e}Gwent Type 5: Gwent-C2030519P4 (Gwent, PET)
^{f}Gwent Type 6: Gwent-C2030519P4 (Gwent, ceramic)
^{g}Dycotec Type 1: Dycotec (in-house printed)
^{h}DropSens Type 1: C11L (DropSens, RE: AgCl, ceramic)
ⁱDropSens Type 2: C110D (DropSens, PANI, ceramic)
^{j}DropSens Type 3: C110 (DropSens, RE: Ag, ceramic)
CV: Coefficient of variance

Generally speaking, a good electrode should have a small ΔEp close to the theoretical value of 59 mV for the selected model redox reaction (single electron transfer), symmetric and reversible oxidation and reduction curves (ipA/ipC close to 1), and large active surface area. From the characterization values of the electrodes printed with IMRE paste/ink formulation (IMRE SPE) or commercially available paste/ink versus commercial carbon electrodes shown in Table 1, it can be seen that IMRE SPEs have the lowest ΔEp and highest active surface area, and relatively good ipA/ipC.

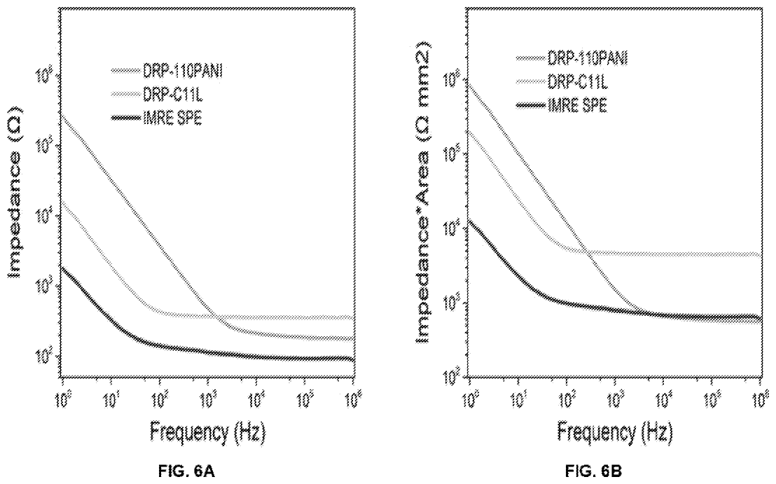

Referring now to FIGS. 6A and 6B, area-normalized impedance of IMRE SPE was compared against commercial carbon electrode C11L and PANI/Carbon electrode C110PANI. FIGS. 6A and 6B respectively show electrochemical impedance and area normalized impedance comparisons between IMRE SPE and commercial carbon electrode C11L and PANI/Carbon electrode C110PANI. As can be seen from FIGS. 6A and 6B, IMRE SPE demonstrates the lowest electrochemical impedance, especially in the low frequency region. The low impedance may be a result of the highly effective electrochemical surface area in the graphite/PEDOT:PSS hybrid system.

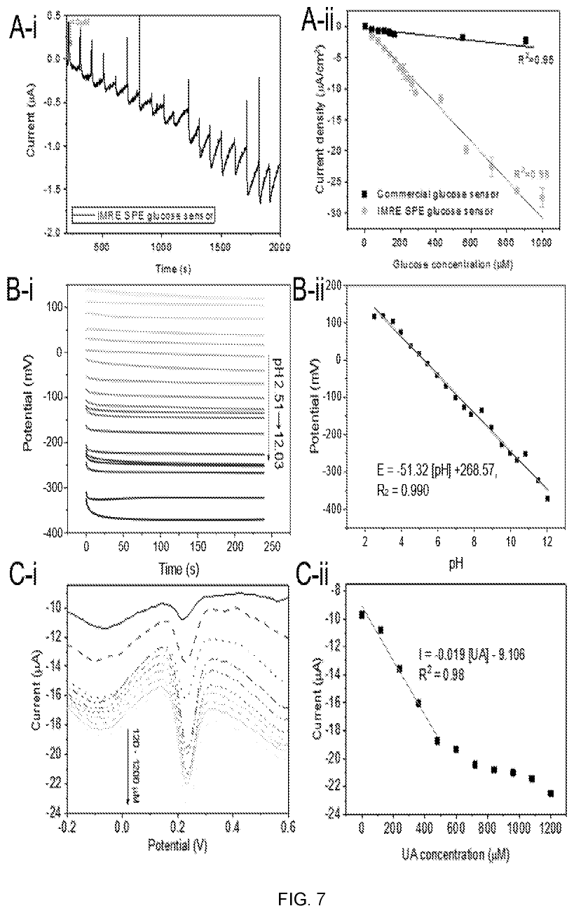

Referring now to FIG. 7, IMRE SPEs were fabricated as functional electrochemical sensors targeting a variety of critical biomarkers. FIG. 7 demonstrates use of IMRE SPEs in the development of various electrochemical sensors: (A) a glucose sensor by amperometry, (B) a pH sensor by measuring open circuit potential and (C) a uric acid sensor by differential pulse voltammetry (DPV).

As can be seen from FIGS. 7A-i and 7A-ii, IMRE SPEs modified with an enzymatic sensing layer may be applied to detect glucose specifically in real-time as shown in FIG. 7A-i, achieving more than 10-fold improvement in detection sensitivity as compared to the commercially available glucose sensor as shown in FIG. 7A-ii. As can be seen from FIGS. 7B-i and 7B-ii, IMRE SPEs are also useful as a pH sensor. By functionalizing the SPEs with a layer of pH-responsive polymer, IMRE SPEs can be applied for pH sensing by measuring the open circuit potential as shown in FIG. 7B-i. A good linear response in the pH range of 2.51 to 12.03 with sensitivity of 51.32 mV/pH is observed in FIG. 7B-ii.

As can be seen from FIGS. 7C-i and 7C-ii, IMRE SPEs may also be applied in differential pulse voltammetry mode to detect uric acid with a distinct current peak at 0.22 V as shown in FIGS. 7C-i, with a linear range from 0-500 μM as shown in FIG. 7C-ii.

The successful demonstration of different types of electrochemical sensors using IMRE SPEs proves their versatility and usefulness in flexible sensor development targeting biochemical markers.

As is evident from the foregoing discussion, the present invention provides a graphite-based paste/ink for electrochemical sensors in the form of a screen-printing ink and a method of manufacturing the same. The graphite-based paste/ink is developed as an aqueous form which is water stable upon printing. A cross-linker is introduced to ensure that it remains stable when immersed in water. The aqueous and hydrophilic paste/ink system includes a conductive polymer binder providing hydrophilic pathways. The present invention also provides a method for producing an electrode for an electrochemical sensor supporting faradaic current, improved ionic conductivity and an enhanced conducting polymer facilitating hydrophilic pathways. The screen-printed electrode includes an enhanced conducting polymer that is cross-linked for mechanical robustness and stability. Use of the screen-printing ink for electrodes greatly enhances both electron transfer kinetics and electroactive surface area, which helps to amplify detection signals. In addition, the electrode surfaces may be carefully tuned to achieve decent hydrophilicity for easy electrode functionalization with subsequent sensing layers.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A screen-printing ink, comprising:
graphite;
an electrically conductive binder to bind the graphite;
a cross-linking agent to cross-link the binder; and
at least one of a conductivity modifier and a hydrophobicity modifier.

2. The screen-printing ink of claim 1, comprising from about 5 percentage by mass (wt %) to about 50 wt % of the graphite.

3. The screen-printing ink of claim 2, comprising from about 10 wt % to about 50 wt % of the graphite.

4. The screen-printing ink of claim 1, comprising from about 50 wt % to about 90 wt % of the electrically conductive binder.

5. The screen-printing ink of claim 1, wherein the electrically conductive binder is selected from a group consisting of poly(3,4-ethylenedioxythiophene) polystyrene sulfonate (PEDOT:PSS), polyacetylene, polyaniline, polypyrrole, polythiophene, poly(para-phenylene), poly(phenylenevinylene) and polyfuran.

6. The screen-printing ink of claim 1, comprising from about 1 wt % to about 20 wt % of the cross-linking agent.

7. The screen-printing ink of claim 6, comprising from about 2 wt % to about 20 wt % of the cross-linking agent.

8. The screen-printing ink of claim 1, wherein the cross-linking agent comprises a methoxysilane compound or divinylsulfone.

9. The screen-printing ink of claim 8, wherein the methoxysilane compound is selected from the group consisting of (3-glycidoxypropyl)trimethoxysilane (GPTMS), 3-chloropropyltrimethoxysilane, 3-methacryloxypropyltrimethoxysilane, and 3-methacryloxypropyltrimethoxysilane.

10. The screen-printing ink of claim 1, comprising from about 1 wt % to about 10 wt % of the conductivity modifier.

11. The screen-printing ink of claim 1, wherein the conductivity modifier is selected from the group consisting of dimethyl sulfoxide (DMSO), ethylene glycol, sorbitol, glycerol, zonyl, phosphoric acid, sulfuric acid, and sulfonic acid.

12. The screen-printing ink of claim 1, comprising from about 1 wt % to about 50 wt % of the hydrophobicity modifier.

13. The screen-printing ink of claim 1, wherein the hydrophobicity modifier is selected from the group consisting of a polyanion, polyurethane, polymethyl methacrylate, and polytetrafluoroethylene.

14. The screen-printing ink of claim 13, wherein the polyanion is selected from the group consisting of a fluoropolymer-copolymer, poly(acrylic acid sodium salt) and poly(ethylene oxide)-block-poly(sodium 4-vinylbenzenesulfonate).

15. A method of manufacturing a screen-printing ink, the method comprising:
mixing graphite in an electrically conductive binder modified with a cross-linking agent and at least one of a conductivity modifier or a hydrophobicity modifier to form a mixture; and
centrifuging the mixture to produce the screen-printing ink.

16. The method of claim 15, wherein the electrically conductive binder is selected from the group consisting of poly(3,4-ethylenedioxythiophene) polystyrene sulfonate (PEDOT:PSS), polyacetylene, polyaniline, polypyrrole, polythiophene, poly(para-phenylene), poly(phenylenevinylene), and polyfuran.

17. The method of claim 15, wherein the cross-linking agent comprises a methoxysilane compound or divinylsulfone.

18. The method of claim 17, wherein the methoxysilane compound is selected from the group consisting of (3-glycidoxypropyl)trimethoxysilane (GPTMS), 3-chloropropyltrimethoxysilane, 3-methacryloxypropyltrimethoxysilane, and 3-methacryloxypropyltrimethoxysilane.

19. The method of claim 15, wherein the conductivity modifier is selected from the group consisting of dimethyl sulfoxide (DMSO), ethylene glycol, sorbitol, glycerol, zonyl, phosphoric acid, sulfuric acid, and sulfonic acid.

20. The method of claim 15, wherein the hydrophobicity modifier is selected from the group consisting of a polyanion, polyurethane, polymethyl methacrylate, and polytetrafluoroethylene.

21. The method of claim 20, wherein the polyanion is selected from the group consisting of a fluoropolymer-copolymer, poly(acrylic acid sodium salt) and poly(ethylene oxide)-block-poly(sodium 4-vinylbenzenesulfonate).

22. A method of producing a screen-printed electrode, the method comprising:
providing a substrate;
screen printing a layer of electrically conductive ink onto the substrate to form an electrically conductive layer;
screen printing a layer of the screen-printing ink of claim 1 onto the electrically conductive layer; and
annealing the printed screen-printing ink to form the screen-printed electrode.

23. The method of claim 22, further comprising:
screen printing an encapsulating layer over the screen-printed electrode; and
annealing the encapsulating layer.

24. The method of claim 23, wherein the encapsulating layer comprises barium titanate.

25. A screen-printed electrode, comprising:
a substrate;
an electrically conductive layer formed on the substrate; and
the screen-printing ink of claim 1 screen-printed onto the electrically conductive layer.
